(19) United States
(12) Patent Application Publication
(10) Pub. No.: US 2010/0107054 A1
(43) Pub. Date: Apr. 29, 2010

(54) Method and apparatus for providing webpage in mobile terminal

(75) Inventor: Sang Min Park, Seoul (KR)

Correspondence Address: CHA & REITER, LLC, 210 ROUTE 4 EAST STE 103, PARAMUS, NJ, 07652, US

(73) Assignee: Samsung Electronics Co., Ltd., Gyeonggi-do (KR)

(21) Appl. No.: 12/584,115

(22) Filed: Aug. 31, 2009

(30) Foreign Application Priority Data
Oct. 24, 2008 (KR) 2008-0105007

(51) Int. Cl. G06F 3/01; G06F 17/00; G06F 3/048

(52) U.S. Cl. 715/234; 715/760; 715/862; 715/808

(57) ABSTRACT

A webpage providing method and apparatus for a mobile terminal includes an RF unit for receiving a webpage and a display unit for displaying the received webpage. A control unit provides for selecting a link of the webpage in response to detection of a signal for focus movement checking whether a mechanism related to a mouse-based scheme is set in a tag of the selected link, and executing the mechanism related to the mouse-based scheme according to a focus-based scheme.

### CLAIM OF PRIORITY

This application claims priority from an application entitled “METHOD AND APPARATUS FOR PROVIDING WEBPAGE IN MOBILE TERMINAL” filed in the Korean Intellectual Property Office on Oct. 24, 2008 and assigned Serial No. 10-2008-0105007, the contents of which are incorporated herein by reference in its entirety.

### BACKGROUND OF THE INVENTION

1. Field of the Invention

The present invention relates generally to a mobile terminal. More particularly, the present invention relates to a webpage providing method and apparatus in a mobile terminal in which a mouse-based employs a mouse-based scheme to provide a webpage.

2. Description of the Related Art

Mobile terminals are widely utilized thanks to a great deal of mobility by users and their demand to ever-increase the capabilities of mobile terminals to store and run various application programs, and other supplementary functions. In particular, a mobile terminal can display a webpage downloaded from a web server through a wireless local area network and mobile communication network. Multiple links to various pages or other data may be contained in such a webpage, and various schemes are employed to select a particular one of the links.

Representative schemes for selecting a link in a webpage include a focus-based scheme that enables navigation among links and is mainly employed in mobile terminals, and a mouse-based scheme that uses a mouse pointer and is mainly employed in typical desktop computers. As the focus-based scheme places the focus on a navigatable link, it enables more accurate navigation in comparison to the mouse-based scheme and easy movement to a desired link in a webpage having multiple neighboring links.

For example, the typical desktop computer employs a mouse-based scheme to provide a webpage. For example, in a mouse-based scheme using a ‘mouseover’ mechanism set in a language such as JavaScript or CSS (Cascading Style Sheets), when the mouse pointer is placed on a particular link of a webpage, lower level elements of the link are listed as a tooltip (a common GUI element, where the user moves the cursor over an item, without clicking, and a small “hover box” appears with supplementary information regarding the item in which the cursor is over.

However, in the focus-based scheme where navigation among links is performed in response to directional keys after the webpage is parsed, although fast and simple navigation among links is possible, mechanisms related to the mouse-based scheme may be not handled.

In the focus-based scheme, when the focus is moved to a particular link in response to a move event, the color of the link is changed to indicate the focus position. At this time, however, lower level elements of the link are not listed on the screen, a corresponding tooltip is not displayed, and movement to a close mark for closing a popup window is not possible.

Further, in the focus-based scheme employed by a typical mobile terminal, a webpage is provided regardless of a mechanism such as a mouseover. Hence, a character on the screen may be hidden by the focus and become illegible, and link navigation for selection using a pull down menu may be not possible.

### SUMMARY OF THE INVENTION

The present invention provides a webpage providing a method and apparatus for a mobile terminal that enables the mobile terminal employing a focus-based scheme to process a webpage using mechanisms related to a mouse-based scheme employed in a typical desktop computer.

The present invention also provides a webpage providing method and apparatus for a mobile terminal that can display, when the focus is moved to a link of a webpage, a list of lower level elements of the link or a tooltip related to the link, and can cause a popup window to be closed through focus movement.

The present invention further provides a webpage providing method and apparatus for a mobile terminal employing a focus-based scheme wherein characters of a webpage can be easily recognized and link navigation is possible on a pull-down menu.

In accordance with an exemplary embodiment of the present invention, there is provided a webpage providing method for a mobile terminal, which includes: receiving a webpage and displaying the received webpage; selecting a link of the webpage in response to detection of a signal for focus movement; checking whether a mechanism related to a mouse-based scheme is set in a tag of the selected link; and carrying out the mechanism related to the mouse-based scheme according to a focus-based scheme.

In accordance with another exemplary embodiment of the present invention, there is provided a webpage providing apparatus for a mobile terminal, including: a display unit for displaying a webpage; and a control unit for selecting a link of the webpage in response to detection of a signal for focus movement, for checking whether a mechanism related to a mouse-based scheme is set in a tag of the selected link, and for carrying out the mechanism related to the mouse-based scheme according to a focus-based scheme.

In one exemplary aspect of the present invention, a mobile terminal employing a focus-based scheme provides a webpage in a convenient manner through the mouseover mechanism related to a mouse-based scheme.

In a focus-based scheme, the focus can be moved to a link indicated by the mouseover mechanism.

When a link specifies a popup window in a focus-based scheme, the focus can be moved to a link in the popup window.

### BRIEF DESCRIPTION OF THE DRAWINGS

The features and advantages of the present invention will be more apparent from the following detailed description in conjunction with the accompanying drawings, in which:

FIG. 1 is a block diagram illustrating a mobile terminal according to an exemplary embodiment of the present invention;

FIG. 2 is a flow chart illustrating exemplary operation of a webpage providing method for a mobile terminal according to another exemplary embodiment of the present invention;

FIGS. 3A to 3C illustrate screen representations related to the webpage providing method of FIG. 2;

FIG. 4 is a flow chart of an exemplary procedure to handle links present in a popup window of a webpage;

FIGS. 5A and 5B illustrate exemplary screen representations related to the procedure of FIG. 4;

FIG. 6 is a sequence diagram illustrating an exemplary procedure to parse a webpage utilizing a DOM parser; and

FIG. 7 is a sequence diagram illustrating an exemplary procedure to parse a webpage utilizing a SAX parser.

### DETAILED DESCRIPTION

Hereinafter, exemplary embodiments of the present invention are described in detail with reference to the accompanying drawings. The same reference symbols are used throughout the drawings to refer to the same or like parts. Detailed descriptions of well-known functions and structures incorporated herein may be omitted to avoid obscuring appreciation of the subject matter of the present invention by a person of ordinary skill in the art.

In the description, ‘parsing’ refers to a process performed by a compiler or interpreter to translate a webpage into a machine executable representation based on a tree structure. During the parsing of a webpage downloaded from a web server, the webpage is analyzed to check whether a mechanism such as ‘mouseover’ or ‘mouseleave’ is set in relation to JavaScript or CSS. A webpage may be parsed through, for example a Document Object Model (DOM) parser, which replaces tags in the webpage, or through a Simple API for XML (SAX) parser, which relates focus movement to mouseover and mouseleave. Parsing using different parsers is described later.

‘Tree structure’ refers to a hierarchy of data items. For example, in a webpage, when a link is elected that has lower level items, the selected link and its lower level items can be listed in a hierarchical tree structure. A tree structure may have multiple levels of data items. In one exemplary aspect of the present invention, independent links form a tree, and in response to selection of one of the links, lower level links of the selected link are displayed in a stepwise manner. That is, a webpage is converted through parsing into a tree structure displayable on the screen.

‘Focus movement’ refers to a process where, after the focus is placed on an initial position, the focus is moved from a particular link to another link in response to a directional key. During focus movement, the link that is focused upon may change color.

The mobile terminal of the present invention preferably comprises a terminal that can provide a webpage, and may be any mobile terminal, including but in no way limited to, for example, a mobile phone, personal digital assistant (PDA), code division multiple access (CDMA) terminal, wideband CDMA (WCDMA) terminal, global system for mobile communications (GSM) terminal, international mobile telecommunications 2000 (IMT 2000) terminal, smart phone, or universal mobile telecommunications system (UMTS) terminal.

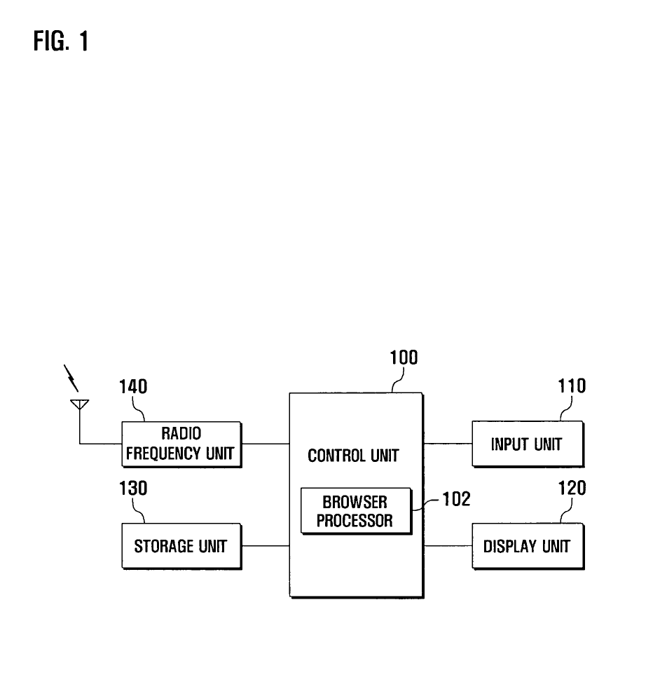

FIG. 1 is a block diagram illustrating a mobile terminal according to an exemplary embodiment of the present invention.

Referring now to FIG. 1, the mobile terminal preferably includes a control unit 100, input unit 110, display unit 120, storage unit 130, and radio frequency unit 140. The control unit 100 includes a browser processor 102.

The input unit 110 preferably includes a plurality of keys for inputting alphanumeric information, and a plurality of function keys for setting various functions. The function keys may include a direction key, side key, and setting key. The input unit 110 may include a touch pad that can provide a touch-sensitive two dimensional image of keys for alphanumeric information or functions in lieu of or addition to physical keys. The input unit 110 sends an input key signal related to user settings and control of the mobile terminal to the control unit 100.

More particularly, when an input signal for link selection in a webpage is input, the input unit 110 receives an input direction key signal for focus movement, and receives a user input signal for selecting one of the links contained in the webpage and sends the link selection signal to the control unit 100. When a popup window is set in a link, the input unit 110 receives an input signal for selecting one of the links contained in the popup window while the popup window is being displayed. The input unit 110 receives an input direction key signal for focus movement, and receives a user input signal for selecting one of the links contained in the popup window and sends the link selection signal to the control unit 100.

The display unit 120 displays operational states of the mobile terminal, operational results, and other various information. The display unit 120 displays menus of the mobile terminal, information input by the user, function setting information, and information to be provided to the user. The display unit 120 may include a panel comprised of any type(s) of display device(s) including but in no way limited to a liquid crystal display (LCD) devices or organic light emitting diodes (OLED). In particular, the display unit 120 displays a webpage received through the radio frequency unit 140 from a web server, a list of lower level items of a selected link of the webpage, and a focus that is moved within the webpage according to direction keys manipulated by the user. Further, when a popup window is set in a link, the display unit 120 displays the popup window.

The storage unit 130 stores, inter alia, application programs for the exemplary embodiments of the present invention. The storage unit 130 may include, for example, a program storage area and a data storage area.

The program storage area stores an operating system for booting the mobile terminal, a web browser for accessing a web server, and a web application program for supporting display of characters in a webpage. The web application program may include, for example, a procedure for parsing a webpage, a procedure for checking whether a mechanism related to the mouse-based scheme is set in the webpage, a procedure for displaying a list of lower level items of a particular link in the form of a tree, a procedure for recognizing the position of the focus that is moved in response to manipulation of a direction key, and a procedure for checking whether a popup window is set in a particular link. The data storage area stores data generated during the use of the mobile terminal, and various types of data related to supplementary functions of the mobile terminal, such as images or moving images captured by a camera function, phonebook data, audio data, and contents and associated descriptive data. In particular, the data storage area stores information regarding a webpage downloaded from a web server.

Still referring to FIG. 1, the radio frequency unit 140 establishes a communication channel between the mobile terminal and a serving base station for wireless communication, including but not limited to a voice call, and sends user data to another mobile terminal. The radio frequency unit 140 also performs communication in cooperation with a web server to receive a webpage and to send and receive control signals related to the webpage. The radio frequency unit 150 may include a radio frequency transmitter for upconverting the frequency of a signal to be transmitted and amplifying the signal, and a radio frequency receiver for low-noise amplifying a received signal and downconverting the frequency of the signal.

The control unit 100 controls the overall operation of the mobile terminal and signal exchange between internal blocks thereof. In particular, upon reception of a user request, the control unit 100 may control the radio frequency unit 140 to receive a webpage from a web server, and control the display unit 120 to display the received webpage. Here, the control unit 100 may also control the browser processor 102 to display the received webpage on the screen. The control unit may include a separate processor in addition to the browser processor to control functionality of the other units.

The control unit 100 parses a webpage to check whether a mechanism related to a mouse-based scheme is set in the webpage. The control unit 100 may employ a DOM parser or a SAX parser to parse the webpage. In parsing of a webpage, the DOM parser checks whether a mechanism related to the mouse-based scheme, such as mouseover or mouseleave in CSS or JavaScript, is set in the webpage, and modifies a corresponding portion of the DOM tree. When the focus is moved to a particular link after creation of the DOM tree, the DOM parser searches the DOM tree for a portion corresponding to focus movement and modifies the contents of the found portion.

In the parsing of a webpage, the SAX parser, for example, parses the webpage in response to event occurrences to facilitate view mode change in webpage display through the focus-based scheme.

Upon reception of an input direction key, the control unit 100 sets the position of the focus.

After positioning the focus, the control unit 100 identifies a previous link and a next (sequential) link with respect to the current link on which the focus is positioned. An input direction key corresponds to a signal for focus movement in the focus-based scheme. The control unit 100 then checks whether a mechanism related to the mouse-based scheme is set in the previous link and next link. For example, in a webpage having a link ‘a’, link ‘b’, and link ‘c’ in sequence, when the focus is placed on link ‘b’, the control unit 100 causes a list of lower level items of link ‘b’ to be displayed through the mouseover mechanism, and analyzes link ‘a’ (the previous link of link ‘b’) and link ‘c’ (the next link of link ‘b’). When the focus is moved from link ‘b’ to link ‘a’ or link ‘c’, the control unit 100 causes a list of lower level items of the link gaining the focus to be displayed through the mouseover mechanism, and causes, at the same time, a list of lower level items of link ‘b’ to no longer be displayed through the mouseleave mechanism. Further, the control unit 100 checks whether a popup window is set in a link of a webpage. If a popup window is set in a link, the control unit 100 checks whether a link is present in the popup window. If a link is present in the popup window, the control unit 100 makes the link in the popup window focusable (i.e., enables the focus to be moved to the link in the popup window).

To make links present in a popup window selectable through focus movement, the control unit 100 makes the links in the popup window focusable. Upon reception of a direction key from the user, the control unit 100 controls focus movement so that the focus can move to a popup window corresponding to the input direction key.

In addition, the control unit 100 controls focus movement so that the focus can move to the ‘close’ mark present in a popup window. When the focus is placed on the ‘close’ mark present in a popup window in response to an input direction key from the user, the control unit 100 closes the popup window.

The browser processor 102 analyzes a webpage in order to display the webpage on the screen under the control of the control unit 100. The browser processor 102 analyzes the webpage to check whether a mechanism related to the mouse-based scheme is set in the webpage.

In response to an input direction key, the browser processor 102 sets the position of the focus. After positioning the focus, the browser processor 102 examines the previous link and a succesive link with respect to the current link on which the focus is positioned. That is, the browser processor 102 checks whether a mechanism related to the mouse-based scheme is set in the previous link and next link.

When the focus is moved from a first link to a second link, the browser processor 102 causes a list of lower level items of the second link to be displayed through the mouseover mechanism, and causes, at the same time, a list of lower level items of the first link to no longer be displayed through the mouseleave mechanism.

The mobile terminal depicted in FIG. 1 includes components used for the description of the exemplary embodiments of the present invention. However, the present invention is not limited thereto, and the mobile terminal may further include at least one of, for example, a camera unit, and/or a digital broadcast receiving unit if necessary.

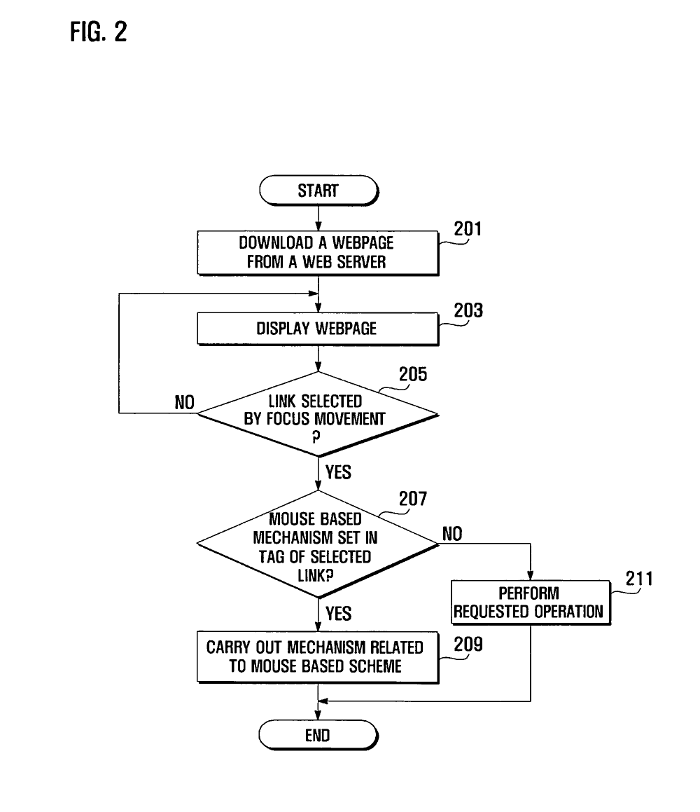

Hereinabove, the mobile terminal is described in terms of a webpage providing capability. Next, an exemplary webpage providing method for a mobile terminal is described in connection with FIGS. 2 to 7.

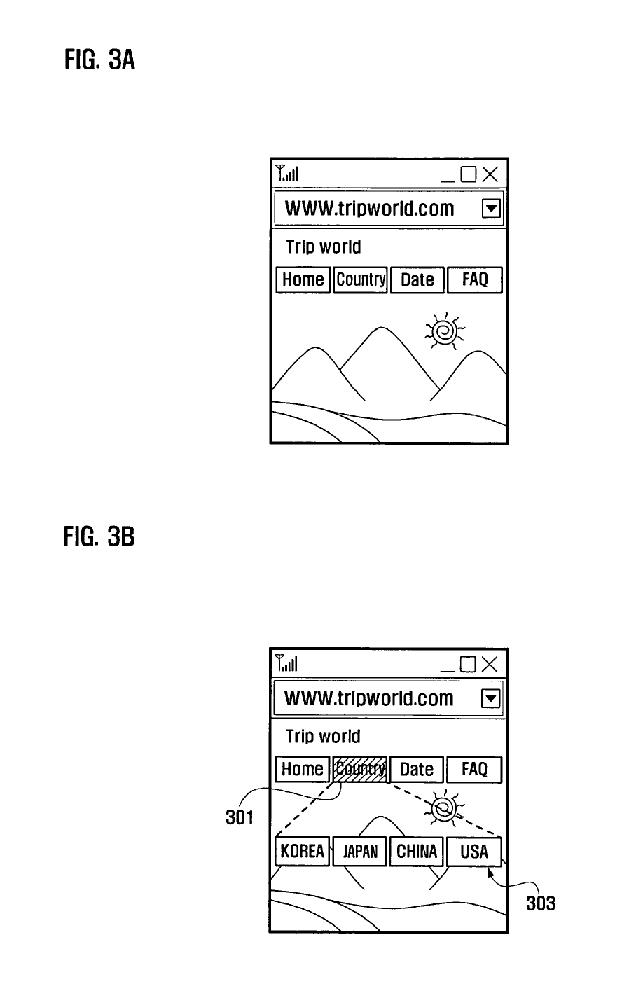

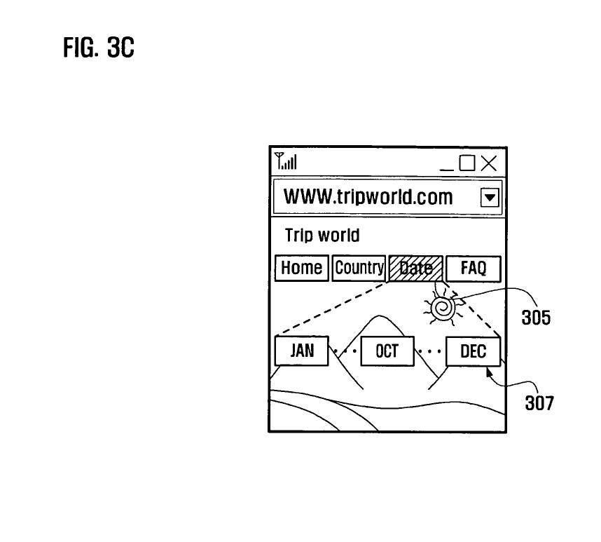

FIG. 2 is a flow chart illustrating a webpage providing method for a mobile terminal according to another exemplary embodiment of the present invention. FIGS. 3A to 3C illustrate screen representations related to the exemplary webpage providing method of FIG. 2.

Referring now to FIG. 2, the control unit 100 (shown in FIG. 1) of the mobile terminal controls the radio frequency unit 140 to receive a requested webpage (typically requested via a browser) that is downloaded from a web server (201), and stores the downloaded webpage in the storage unit 130. The control unit 100, in association with the web browser, displays the downloaded webpage on the screen (203). FIG. 3A illustrates display of a webpage on the screen.

The control unit 100 checks whether a particular link is selected (205). The control unit 100 may select a link, for example, on the basis of focus movement caused by an input direction key.

When no link is selected at (205), the control unit 100 continues to display the webpage.

When a link is selected at (205), the control unit 100 checks whether a mechanism related to the mouse-based scheme has been set in the tag of the selected link (207). The control unit 100 performs a procedure to parse the webpage. Webpage parsing may be performed using a DOM parser or a SAX parser, and is detailed hereinafter.

When at (207), a mechanism related to the mouse-based scheme has not been set in the tag of the selected link, the control unit 100 performs a requested operation (211). For example, the webpage may be displayed using the focus-based scheme.

When at (207) the mechanism related to the mouse-based scheme has been set in the tag of the selected link, the control unit 100 performs the mechanism related to the mouse-based scheme (209). That is, the control unit 100 makes use of a mouse-based feature during focus-based processing. The mechanism related to the mouse-based scheme may be, for example, various GUI events that include ‘mouseover’ or ‘mouseleave’ mechanisms. When the focus is moved from a first link to a second link in response to an input direction key from the user, the control unit 100 causes a list of lower level items of the second link to be displayed through the mouseover mechanism, and causes a list of lower level items of the first link to no longer be displayed through the mouseleave mechanism.

For example, as shown in FIG. 3B, when the focus is placed on a link ‘Country’ 301, the control unit 100 displays a list 303 of lower level items ‘Korea’, ‘Japan’, ‘China’ and ‘USA’ of the link ‘Country’ 301 through the mouseover mechanism. However, as shown in FIG. 3C, when the focus is moved to a link ‘Date’ 305, the control unit 100 discontinues displaying a list of lower level items of the previous link through use of the mouseleave mechanism, and displays a list 307 of lower level items of link ‘Date’ 305 through use of the mouseover mechanism.

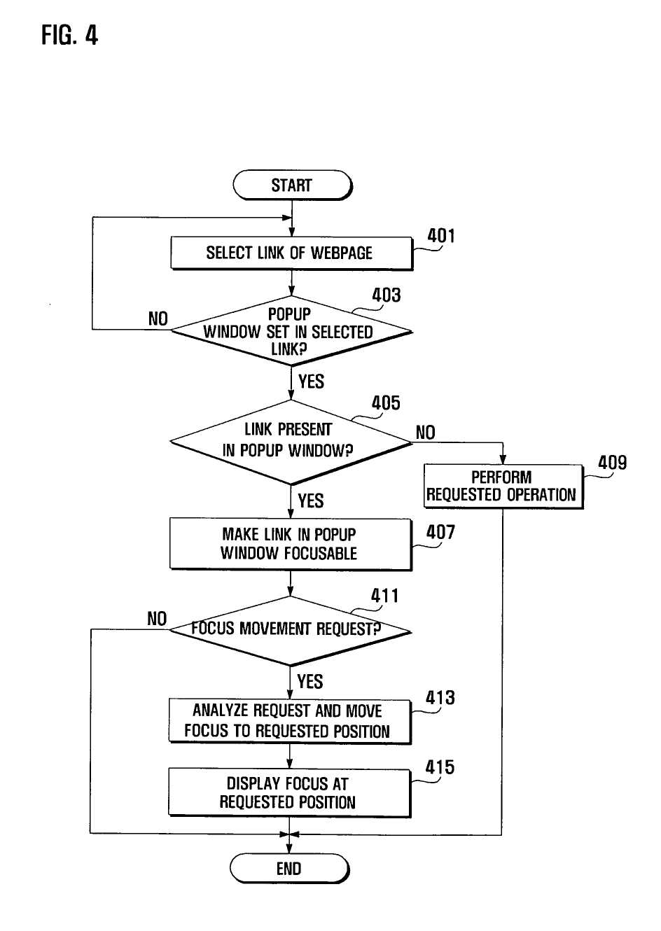

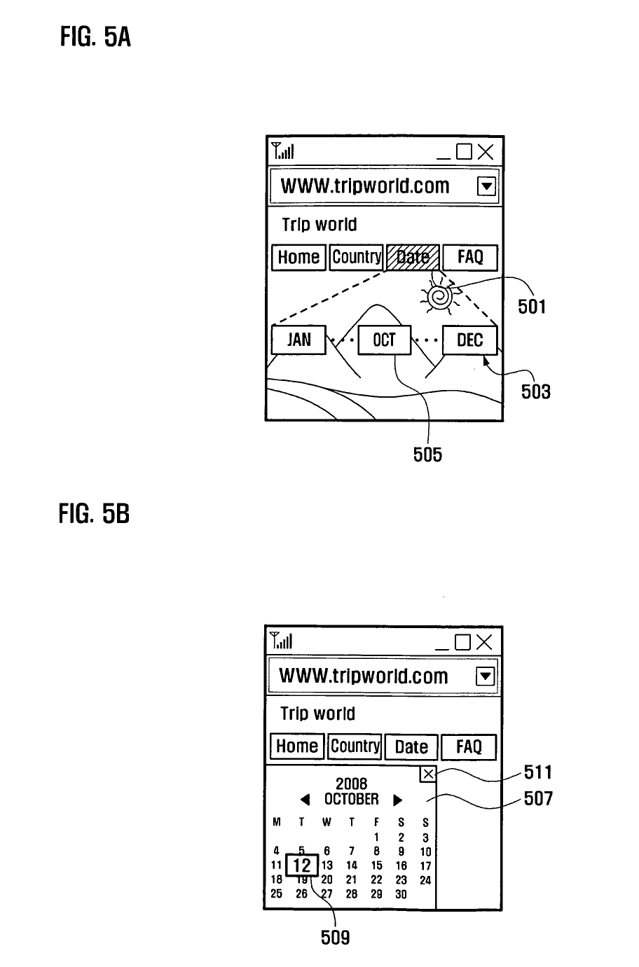

FIG. 4 is a flow chart of an exemplary operational procedure to handle links present in a popup window of a webpage according to the present invention. FIGS. 5A and 5B are illustrations of screen representations related to the exemplary procedure of FIG. 4.

Referring now to FIG. 4, in response to an input signal that for example, was received from activation of a directional key input, the control unit 100 selects a link of a webpage through focus movement (S401). For example, as shown in FIG. 5A, the control unit 100 selects a link ‘Date’ 501 of a webpage in response to an input signal, and causes a list 503 of lower level items of link ‘Date’ 501 to be displayed through the mouseover mechanism. In response to another input signal, the control unit 100 may select item ‘Oct’ 505 of link ‘Date’ 501.

The control unit 100 checks whether a popup window has been set in the selected link (403). When a popup window has not been set in the selected link, the control unit 100 continues to select a link in the webpage. When a popup window has been set in the selected link, the control unit 100 checks whether a link is present in the popup window (405).

When at (405), no link is present in the popup window, the control unit 100 performs a requested operation (409). The control unit 100 may display a list of lower level items of the current link according to focus movement.

However, when at (405) a link is present in the popup window, the control unit 100 makes the link in the popup window focusable according to the focus-based scheme (407). For example, as shown in FIG. 5B, the control unit 100 controls focus movement so that the focus can be moved to a specific date 509 in a calendar popup window 507. The control unit 100 also makes the close mark 511 of the popup window 507 focusable so that the popup window 507 can be closed through focus movement.

Still referring to FIG. 4, at (411) the control unit 100 checks whether a focus movement request is issued. A focus movement request may be issued through input of a direction key.

When a focus movement request is issued, the control unit 100 analyzes the request and moves the focus to the requested position (413).

Now at (415), the control unit 100 displays the focus at the requested position. For example, as shown in FIG. 5B, in response to an input direction key, the control unit 100 places the focus on a specific date 509 and displays the focus at the requested position.

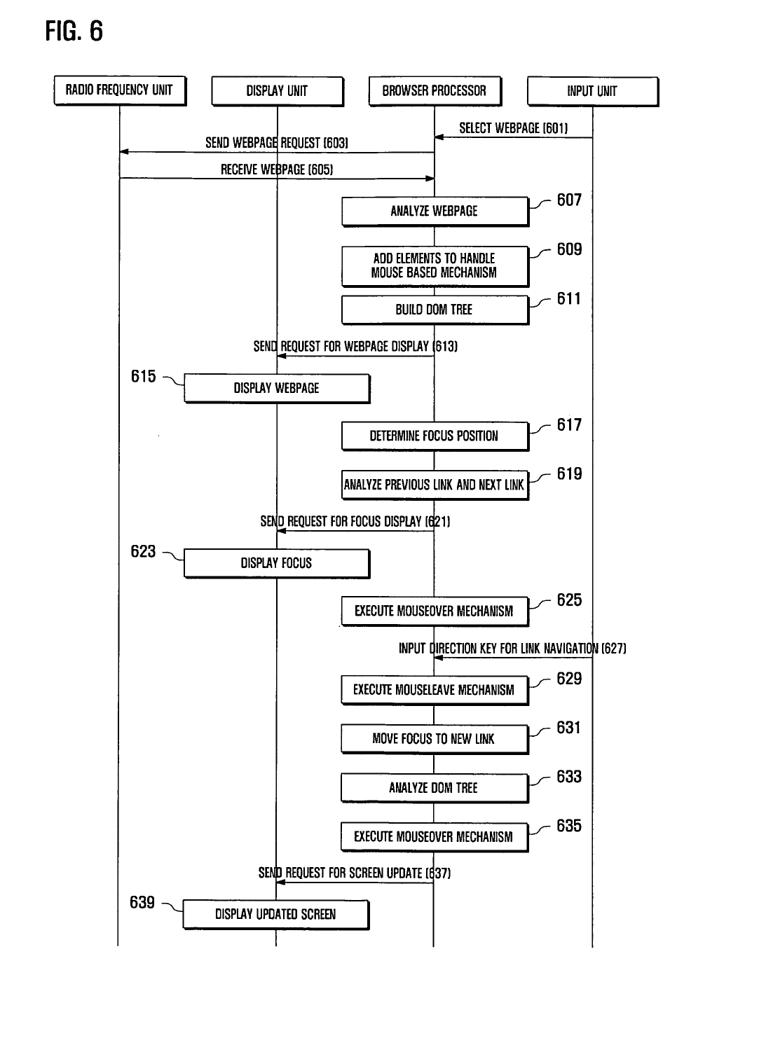

FIG. 6 is a sequence diagram illustrating an exemplary operational procedure to parse a webpage utilizing a DOM parser according to the present invention in conjunction with the exemplary block diagram of the mobile terminal shown in FIG. 1.

Referring now to FIG. 6, when the browser processor 102 of the control unit 100 receives an input signal for webpage selection from the input unit 110 (601), it controls the radio frequency unit 140 to transmit a webpage request to a web server (603). Thereafter, the browser processor 102 receives a webpage transmitted to and received by the radio frequency unit 140 (605).

The browser processor 102 analyzes the received webpage (607) to determine its display and associated functionality. The browser processor 102 checks whether a mechanism, such as, for example, a GUI event-based mechanism related to the mouse-based scheme is set in a link of the webpage. For example, the browser processor 102 checks whether mechanisms such as mouseover or mouseleave have been set in an upper level tag of a link.

The browser processor 102 adds elements to handle the mechanism(s) related to the mouse-based scheme in the focus-based scheme (609).

The browser processor 102 composes links of the webpage into a DOM tree (611). After composition of the DOM tree, the browser processor 102 requests the display unit 120 to display the webpage (613). Upon request, the display unit 120 displays the webpage on the screen (615).

The browser processor 102 determines the current link on which the focus is to be placed (617). Thereafter, the browser processor 102 analyzes the previous link and next link (619). For example, when link ‘a’, link ‘b’, and link ‘c’ are present in sequence in the webpage, the browser processor 102 may determine that the focus is placed on link ‘b’ and analyze link ‘a’ as the previous link and link ‘c’ as the next link, which are links to which the focus presently on link ‘b’ may be moved.

The browser processor 102 requests the display unit 120 to display the focus (621). Upon request, the display unit 120 displays the focus on the screen (623). The browser processor 102 causes a list of lower level items of the current link having the focus to be displayed by executing the mouseover mechanism (625).

When the browser processor 102 receives an input direction key for link navigation (627), it causes the list of lower level items of the current link to no longer be displayed by executing the mouseleave mechanism (629).

The browser processor 102 moves the focus to a new link corresponding to a directed area of the web page specified by a number of keystrokes of the input direction key (631). The browser processor 102 traverses the DOM tree to analyze links navigatable from the new link (633). The browser processor 102 causes a list of lower level items of the new link to be displayed through execution of the mouseover mechanism (635).

The browser processor 102 requests the display unit 120 to update the screen so as to display the focus on the new link (637). Upon the screen update request, the display unit 120 displays the updated screen (639).

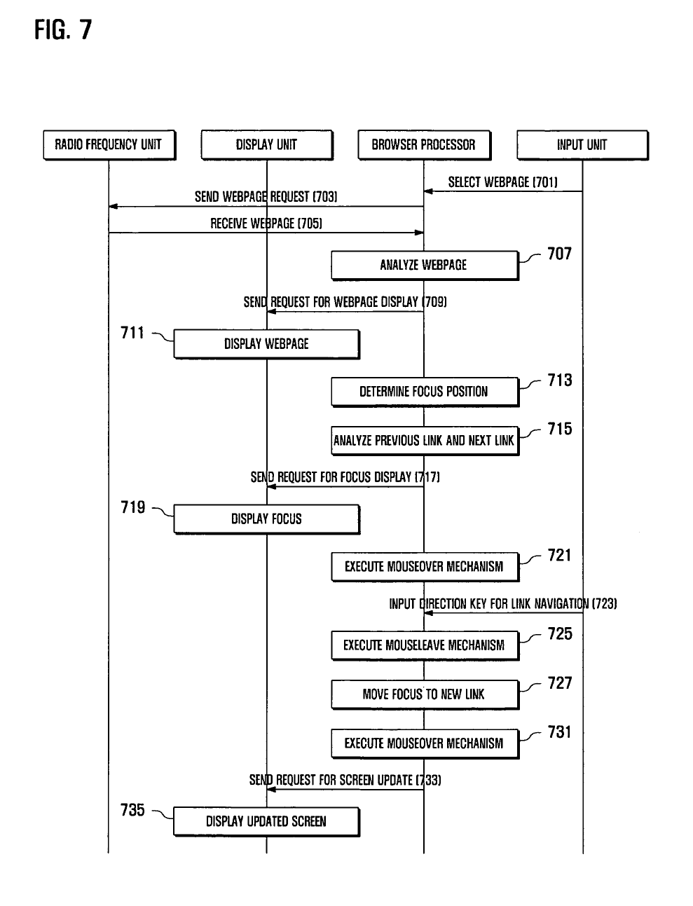

FIG. 7 is a sequence diagram illustrating an exemplary procedure to parse a webpage utilizing a SAX parser in conjunction with the exemplary block diagram of a mobile terminal shown in FIG. 1. A person of ordinary skill in the art understands and appreciates that the claimed invention is not limited to the examples shown and provided herein.

Referring now to FIG. 7, when the browser processor 102 of the control unit 100 receives an input signal for webpage selection from the input unit 110 (701), the browser processor controls the radio frequency unit 140 to transmit a webpage request to a web server (703). Thereafter, the browser processor 102 receives a webpage transmitted from the web server and received by the radio frequency unit 140 (705).

The browser processor 102 analyzes the received webpage (707). The browser processor 102 checks whether a GUI event mechanism related to the mouse-based scheme is set in a link of the webpage. For example, the browser processor 102 checks whether a mechanism such as mouseover or mouseleave is set in an upper level tag of a link.

After webpage analysis, the browser processor 102 requests the display unit 120 to display the webpage (709). Upon request, the display unit 120 displays the webpage on the screen (711).

The browser processor 102 determines the current link on which the focus is to be placed (713). Thereafter, the browser processor 102 analyzes the previous link and next link (715).

The browser processor 102 requests the display unit 120 to display the focus (717). Upon request, the display unit 120 displays the focus on the screen (719). The browser processor 102 causes a list of lower level items of the current link having the focus to be displayed through the mouseover mechanism (721).

When the browser processor 102 receives an input direction key for link navigation (723), it causes the list of lower level items of the current link to no longer be displayed through the mouseleave mechanism (725).

The browser processor 102 moves the focus to a new link corresponding to the input direction key (727). The browser processor 102 traverses the DOM tree to analyze links navigatable from the new link (729). The browser processor 102 causes a list of lower level items of the new link to be displayed through the mouseover mechanism (731).

The browser processor 102 requests the display unit 120 to update the screen so as to display the focus on the new link (733). Upon the screen update request, the display unit 120 displays the updated screen (735).

Although exemplary embodiments of the present invention have been described in detail hereinabove, it should be understood that many variations and modifications of the basic inventive concept herein described, which may appear to those skilled in the art, will still fall within the spirit and scope of claimed invention, as defined herein in the appended claims.

What is claimed is:

1. A webpage providing method for a mobile terminal, comprising:
receiving a webpage by a Radio Frequency (RF) communication unit and displaying the received webpage on a display;
selecting a link of the webpage by a control unit in response to detection of a signal for focus movement generated by an input unit;
checking, by the control unit, whether a mechanism related to a mouse-based scheme is set in a tag of the selected link; and
performing, by the control unit, the mechanism related to the mouse-based scheme according to a focus-based scheme.

2. The webpage providing method of claim 1, wherein said focus movement comprises moving a focus from a current link to another link according to a direction specified by an input direction key signal generated by the input unit.

3. The webpage providing method of claim 1, wherein checking whether a mechanism related to a mouse-based scheme is set comprises checking whether a ‘mouseover’ mechanism or a ‘mouseleave’ mechanism is set in the selected link.

4. The webpage providing method of claim 1, wherein performing the mechanism related to the mouse-based scheme comprises providing that a list of lower level items of the selected link associated with the focus are displayed via a ‘mouseover’ mechanism.

5. The webpage providing method of claim 4, wherein the list of lower level items is represented by a hierarchical tree structure.

6. The webpage providing method of claim 1, wherein checking whether a mechanism related to a mouse-based scheme is set is performed on the basis of parsing utilizing a Document Object Model (DOM) parser or a Simple API for XML (SAX) parser.

7. The webpage providing method of claim 1, wherein checking whether a mechanism related to a mouse-based scheme is set comprises:
determining, upon detection of a signal for focus movement, a direction corresponding to the focus movement signal;
identifying, with respect to the determined direction, the previous link and a next link of a current link having the focus; and
determining whether a mechanism related to the mouse-based scheme is set in the previous link and the next link.

8. The webpage providing method of claim 1, wherein performing the mechanism related to the mouse-based scheme comprises providing that when the focus is moved from a first link to a second link, a list of lower level items of the first link is no longer be displayed by utilizing a ‘mouseleave’ mechanism.

9. The webpage providing method of claim 1, wherein checking whether a mechanism related to a mouse-based scheme is set comprises:
checking whether a popup window is set in the selected link;
checking, when a popup window is set in the selected link, whether an additional link is present in the popup window;
processing, when the additional link is present in the popup window, the additional link according to the focus-based scheme.

10. The webpage providing method of claim 9, wherein processing the link in the popup window comprises moving the focus from the popup window to the link in the popup window in response to a focus movement signal, and closing the popup window according to the focus-based scheme.

11. A webpage providing apparatus for a mobile terminal, comprising:
a display unit for displaying a webpage; and
a control unit for selecting a link of the webpage in response to detection of a signal for indicating a focus movement, for checking whether a mechanism related to a mouse-based scheme is set in a tag of the selected link, and for carrying out the mechanism related to the mouse-based scheme according to a focus-based scheme.

12. The webpage providing apparatus of claim 11, wherein the signal indicating the focus movement comprising an input key direction signal made by moving the focus from a current link to another link.

13. The webpage providing apparatus of claim 11, further comprising a browser processor for checking whether a ‘mouseover’ mechanism or ‘mouseleave’ mechanism is set in the selected link.

14. The webpage providing apparatus of claim 11, wherein the control unit provides that a list of lower level items of the selected link having the focus are displayed by executing a ‘mouseover’ mechanism.

15. The webpage providing apparatus of claim 14, wherein the list of lower level items is represented by a hierarchical tree structure.

16. The webpage providing apparatus of claim 11, wherein the control unit employs one of a Document Object Model (DOM) parser and a Simple API for XML (SAX) parser to parse the webpage.

17. The webpage providing apparatus of claim 11, wherein the control unit determines, upon detection of a signal for focus movement, a direction corresponding to the focus movement signal, identifies, with respect to the determined direction, the previous link and next link of the selected link having the focus, and determines whether a mechanism related to the mouse-based scheme is set in a previous link and a next link.

18. The webpage providing apparatus of claim 11, wherein the control unit provides that when the focus is moved from a first link to a second link, a list of lower level items of the first link are no longer displayed through executing a ‘mouseleave’ mechanism.

19. The webpage providing apparatus of claim 11, wherein the control unit checks for whether a popup window is set in the selected link, determines, when a popup window is set in the selected link, whether an additional link is present in the popup window, and processes the additional link in the popup window according to the focus-based scheme.

20. The webpage providing apparatus of claim 19, wherein the control unit moves the focus from the popup window to the link in the popup window in response to detection of a focus movement signal, and closes the popup window according to the focus-based scheme.
